(19) United States
(12) Patent Application Publication
(10) Pub. No.: US 2008/0070652 A1
(43) Pub. Date: Mar. 20, 2008

(54) Reduced power consumption wager gaming machine

(75) Inventors: Binh T. Nguyen, Reno, NV (US); Brian Underdahl, Reno, NV (US)

Correspondence Address: BEYER WEAVER LLP, P.O. BOX 70250, OAKLAND, CA, 94612-0250, US

(73) Assignee: IGT, Inc., Reno, NV (US)

(21) Appl. No.: 11/522,700

(22) Filed: Sep. 18, 2006

(51) Int. Cl. A63F 13/00

(52) U.S. Cl. 463/1

(57) ABSTRACT

Novel wager gaming machines, gaming servers, and power consumption control methods for intelligently controlling power consumed by a wager gaming machine in a manner that does not discourage or prevent use of the gaming machine are described. A component of a gaming machine, for example, a ticket printer, is powered down when it has been determined that, based on usage pattern data, the component is not likely to be used. Usage pattern data are derived from raw activity usage data for a machine and its components. Components that are not powered based on the usage pattern data can be powered upon detecting an action implying that a user will be using the machine, for example, a card read or bill insert. A power controller processes signals conveying rules based on the usage pattern data and may also process a signal conveying a user-initiated action if there is one, to form a command to power up or turn off one or more gaming machine components.

### BACKGROUND OF THE INVENTION

1. Field of the Invention

The present invention relates to wager gaming networks and gaming machines for playing games of chance. More specifically, it relates to managing and allocating electrical power consumed by wager gaming networks, gaming machines, and gaming machine components and peripherals.

2. Description of the Related Art

Gaming is an increasingly popular industry, with casinos and other gaming establishments continually seeking new and exciting ways to present games of chance for play. Many wagering games are typically presented on large, free-standing or stand-alone gaming devices, such as electronic slot machines, video poker machines and the like.

Energy consumption at casinos and gaming establishments has been increasing for many years. As the number of electronic gaming machines has grown, the more power casinos and gaming establishments consume and as energy costs have been rising, this has greatly increased the cost of operating the current generation of gaming machines. For example, if the total power consumption of an average gaming machine (including the top box and various lights) is about 400 watts, it costs a casino around $280 per year to run the machine. For a casino with 3,000 gaming machines, the power costs could easily top $800,000 per year, not taking into account the increased cost of air conditioning necessary to offset the heat generated by the machines. Reducing the power consumption by 35%-40% could easily save a large gaming operation over $300,000 a year at current rates.

One of the time-honored marketing and image-creating strategies of the gaming industry is that the vast majority of gaming machines in a casino are essentially always on. The flashing lights, sounds, and continual operating state of nearly all of a gaming machine's components and peripherals, such printers, card readers, bill validators, hoppers, and so on, all require power and are, in fact, powered at all times. There are a number of reasons for this mode of operation at gaming establishments. One is that gaming operators, as entities in many other businesses, are always seeking to attract potential users to their products and services. In casinos these potential users are often people who are passing by the gaming machines and whose attentions are often drawn to, for example, a video poker machine because of lights and sounds (sometimes referred to as “attract sequences”) which, the gaming industry has long-believed must always be on. It has been assumed that certain components and peripherals must also always be powered given that potential wager gaming machine users are thought of as having little patience to wait for components to power up, such as longer than one or two seconds. Thus, for these and various other reasons, gaming machines are often on “24/7” and are typically brought down only for maintenance or repair.

Other tangential and incidental energy drains from the constant operation of thousands of gaming machines at many gaming establishments include the increased need for climate control, such as air conditioning and ventilation, to compensate for the heat released from the gaming machines. Generally, the gaming industry believes—and data from electrical utility companies confirm—that significant financial savings can be realized from more intelligent use of power in gaming machines. Moreover, intelligent and more refined use of power will conserve our natural resources.

In spite of these benefits, the gaming industry has been slow to adapt power reduction measures in gaming machines. It is reluctant to alter its conventional marketing methods or change its image. A nearly immutable element of the gaming business in the U.S. and around the world is that it is flashy and attention grabbing. This is what the vast majority of gamers have come to expect and, therefore, is not likely to change radically anytime in the near future. Although there have been some incremental changes over the years, none have significantly affected the power consumption of wager gaming machines. For example, sound emitted from some machines can be adjusted by a gaming operator or by a player by using a slider mechanism to control volume. However, even this small concession by the gaming operators was motivated by a need to reduce noise irritation rather than power consumption. Of course, gaming operators can manually turn off individual gaming machines, machine components and peripherals, or an entire bank of gaming machines. However, the powering down of machines is not done automatically or, more importantly, intelligently for the purpose of saving energy while concurrently not affecting the ability to attract potential gamers or falling short of expectations from playing wagering games on the modern gaming machine.

It would be desirable to provide gaming machines and networks that use less power, while satisfying the needs and desires of the gaming industry.

### SUMMARY OF THE INVENTION

Novel wager gaming machines, gaming servers, and gaming networks are described for intelligently reducing power consumption in wager gaming machines. A gaming network having multiple gaming machines operating at various locations in a gaming establishment can be organized into zones. For example, a casino floor may have an elaborate configuration of electronic wager gaming machines. A gaming operator can create zones of machines within the configuration. Software tools or native gaming machine commands can be used to derive a “heat map” of the floor based on the zones where such a map provides an average level of usage of machines in a particular zone over certain intervals. This activity usage data set may be used as one factor in controlling the power supply to gaming machines, such that all components of a gaming machine are not fully powered at all times. A few examples of data points that are measured to derive overall activity of a gaming machine may include payouts, bills/coins accepted, tickets printed, and card reads.

Many wager gaming machines contain power-consuming components or peripherals, such as displays, lights, printers, card readers, hoppers, and so on. One way to reduce the power consumption in a gaming machine is by reducing or cutting energy to individual components when it has been determined that, given a certain temporal or spatial context, the components are not likely to be used or activated. Thus, if it has been determined from activity usage patterns that at 4 am on a Tuesday, a machine is not likely to be used, most or all the components can be powered down. In another example, if a machine is at a location where it is not used often regardless of the time or day, certain components can be powered down at all times. In this case and many others, it is desirable to be able to power up the components that are “turned off” quickly based on a user-initiated action that can occur at any time and is generally unpredictable. A few examples of these actions, generally “local” to the gaming machine, include a bill or coin insert, a card insert, button or keyboard activation, and even pausing within a few feet of the machine. These actions may indicate use or potential use of the gaming machine, thereby possibly requiring that all or some components be powered on to enable game play. The thresholds of average activity usage pattern levels for powering down components of a gaming machine and which types of user-initiated actions will power up components can be set by the gaming operator and adjusted to meet the operator's power-saving goals.

This type of fine tuning is enabled in part by use of one or more power controllers that can reside and operate on a gaming machine, a gaming server, such as a dedicated power control system server or on a server-based gaming (“SBG”) server, or on a multi-station gaming device, such as a gaming table or carousel. A power controller may be embedded on a CPU board, its own board, be implemented as an ASIC, or be implemented as a software module, or combinations thereof. Functions within a power controller are capable of receiving and processing a signal from a source that supplies data, e.g., a rule or command, derived from average, zone-based activity usage patterns for a gaming machine zone. These same functions within the power controller are also capable of receiving another type of signal from a source that supplies data on an event or action that is generally first detected by the gaming machine and can be described as a “local” factor, in contrast, the signal derived from zone-based and component-based usage pattern data which can be characterized as a global or external factor. The power controller can process both these signals, only one, or additional usage-related data to create instructions to power down or power up components of one or more wager gaming machines. It can also store raw activity usage data and usage pattern data for gaming machine components.

In a gaming network, gaming machines may perform their power reducing techniques in conjunction with a power control system server or server process operating on another suitable network server. Several types or categories of usage and power-related data may be stored, analyzed, and processed on the server side. In some embodiments, these data may include activity usage data and average usage pattern data for each zone in a gaming network and the same type of data for components for each gaming machine under control of server or server process. The server may also include rule and condition data based on the various categories of activity data and usage pattern data. Based on these rule and condition data, a server may instruct gaming machines in a zone or a single gaming machine to cut power or power up certain components because, for instance, the time has entered a certain time interval of a certain day or because a machine has been moved to a new location, and so on.

One aspect of the present invention is a wager gaming machine that has one or more components or peripherals, such as a bill validator, coin hopper, disk drives, displays, card readers, and the like, each of which consume power. The machine also has at least one processing unit or CPU that controls operation of a component. Executing in conjunction with the CPU is a power controller that is capable of controlling power supplied to the component based, at least in part, on usage pattern data of the component derived from raw activity usage data.

In one embodiment, the power controller also controls power supply to the component according to a user-initiated action or event performed on the gaming machine. In another embodiment, the power controller combines rule and condition data based on usage pattern data with data relating to user-initiated actions to determine whether to supply power to the component. In another embodiment, a power distribution panel has ports and relays connecting it to one or more gaming machine components. It is also connected to the power controller from which it receives power-related commands for cutting power or supplying power to the components. In yet another embodiment, the power controller stores raw activity data and usage pattern data relating to one or more components.

In another aspect of the invention, a power control server for use in a gaming network having multiple wager gaming machine zones stores various categories of activity usage data, usage pattern data, and rule and condition data relating to power consumption of gaming machine components. A power control server or other suitable server in the network capable of storing and processing gaming machine usage and power-related data, can have one or more zone-data repositories storing activity data for a gaming machine zones, usage pattern data for the zones, and activity and usage pattern data for gaming machine components for machines under purview of the power control server. The server can also store rule and condition data for supplying power to the wager gaming machines in the zones under the control of the server, the rule and condition data being derived, at least in part from usage pattern data for a gaming machine zone and the gaming machine components. In some embodiments, the power control server also contains a power controller for processing the rule and condition data and creating a power-related command that is transmitted to one or more gaming machines. In other embodiments, the power controller also processes a signal representing a user-initiated action taken on a specific gaming machine, such as a bill or card insertion or button activation.

Another aspect of the present invention is a method of controlling power supplied to a wager gaming machine that includes monitoring the usage activity of a wager gaming machine, such as by keeping track of machine payouts, card insertions, printer activity, and the like. From this usage activity data, usage pattern data are derived for a gaming machine. These usage pattern data are used to supply power to components of the gaming machine in such a manner that a component that is not likely to be used at a specific time, for example, according to the usage pattern data, will be turned off thereby not consuming energy. In one embodiment a local-factor signal representing an action taken by a user on the gaming machine is received. The signal may be used to adjust power presently being supplied to the gaming machine according to usage pattern data of the gaming machine. In another embodiment usage pattern data for a gaming machine component are derived based on component activity usage data, such as the frequency of card reads, bill inserts, printer usage, and so on.

In yet another aspect of the present invention, a method of supplying power to components of a wager gaming machine is described. A first signal is received from a first source, the first signal conveying an initial power-related command relating to one or more of the gaming machine components. A second signal is generated at the wager gaming machine that conveys a gaming machine-related event or action that implies use or potential use of the gaming machine. A third signal is created from the first and second signal, or if one of the signals is absent, the third signal embodies the signal that is present, wherein the third signal conveys power-related conditional data. A final power-related command is generated by examining the third signal and used to control power supply to gaming machine components. In some embodiments the first signal may be referred to as an external signal in that it is externally supplied to a gaming machine and conveys data relating to gaming machine usage pattern data stored and supplied by a power control server or other server in the network. In some embodiments, the second signal may be characterized as a local-factor signal in that it is generated by a gaming machine as a result of an action being taken on the machine by a user or potential user.

Some embodiments of the present invention are computer-readable storage mediums, for example tangible computer program products such as CD-ROMs or USB memory devices, that store computer code that can be executed on a wager gaming machine, general-purpose computers, gaming network servers, and various other computer and network devices. The computer code contains instructions for executing the method aspects of the present invention described above for implementing power consumption control in a gaming network having one or more gaming machine zones.

The present invention provides hardware (such as power controllers, gaming machines, power control system servers, network devices and so on) that is configured to perform the methods of the invention, as well as software to control devices to perform these and other methods.

These and other features of the present invention will be presented in more detail in the following detailed description of the invention and the associated figures.

### BRIEF DESCRIPTION OF THE DRAWINGS

References are made to the accompanying drawings, which form a part of the description and in which are shown, by way of illustration, specific embodiments of the present invention:

FIGS. 1A and 1B are top-views of gaming machine floor layouts showing possible gaming machine zones.

FIG. 2 is a sample graphical representation showing average usage levels of gaming machines in a zone.

FIG. 3 is an overview flow diagram of a process of obtaining usage pattern data in accordance with one embodiment of the present invention.

FIG. 4 is a block diagram showing gaming machine hardware and power-related devices as they relate to the power control system of the present invention.

FIG. 5 is a block diagram showing details of CPUs and distribution of power to components in accordance with one embodiment of the present invention.

FIG. 6 is a block diagram showing a power controller and a power distribution panel for a CPU in accordance with one embodiment of the present invention.

FIG. 7 is diagram showing data components and their organization on a power control server in accordance with one embodiment of the present invention.

FIG. 8 is a diagram of a power control process for processing rules and conditions relating to power consumption by components of a gaming machine in accordance with one embodiment of the present invention.

FIG. 9 is a diagram showing relevant power control components in a generic multi-station gaming apparatus connected to a power control system server in accordance with one embodiment of the present invention.

FIG. 10 is a diagram showing a peer-to-peer type configuration in which a power consumption control system is implemented among multiple gaming machines.

FIG. 11 illustrates one example of a gaming network topology for implementing certain aspects of the present invention.

FIG. 12 is a block diagram illustrating a simplified gaming network topology for implementing an arbiter in a gaming network of the present invention.

FIG. 13 is a perspective drawing of a free-standing gaming machine and its external components and features.

FIG. 14 is an illustration of a free-standing gaming machine and a gaming network.

FIG. 15 is an illustration of a network device that may be configured for implementing some methods of the present invention.

### DETAILED DESCRIPTION OF THE INVENTION

Exemplary applications of networks, systems and methods according to the present invention are described. These examples are provided solely to add context and aid in the understanding of the invention. Thus, it will be apparent to one skilled in the art that the present invention may be practiced without some or all of the specific details described herein. In other instances, well-known process steps, system components, and software and network concepts have not been described in detail in order to avoid unnecessarily obscuring the present invention. Other applications are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

For example, although the present invention is directed primarily to wager gaming machines, networks, and servers, it is worth noting that some of the systems and methods disclosed herein might be adaptable for use in other types of networks and environments, such that their use is not restricted exclusively to the wager gaming context. In fact, it will be readily appreciated that, for example, a wide variety of power distribution and allocation hardware devices and activity usage monitoring tools can be used in conjunction with the inventive systems and methods disclosed herein. Such other adaptations may become readily apparent upon review of the following detailed description. Although such other applications can be used with the inventive systems and methods disclosed herein, for purposes of clarity the discussion here shall focus on examples involving actual gaming machines and servers for purposes of clarity.

A power consumption control system to control energy provided to a wager gaming machine in a gaming network is described in the figures. The power control system enables a gaming operator fine tune electrical power supply to components of a gaming machine in an intelligent manner so that power is not wasted on gaming machines when it is determined that the machine or component is not likely to be in use. The control system can also be used in other wager gaming machine configurations such as multi-station gaming tables, peer-to-peer networks, stand-alone machines, and variations thereof.

In the context of a gaming network, a preferred embodiment of the power consumption control system of the present invention is used to control energy consumption of components of a gaming machine from examining activity usage data from a single machine and from a zone of machines. In a preferred embodiment, a primary underlying characteristic of machines in the same zone is their physical proximity. In another example, a zone may be comprised of all gaming machines located in a corner of the casino floor or all machines located on or near a main thoroughfare in a casino. Zones may also be defined according to factors other than physical proximity, such as historical or present levels of gaming activity, the number of nearby patrons, etc. For example, zones may be defined according to historical usage data, activity levels, patron traffic patterns, etc., as described elsewhere herein.

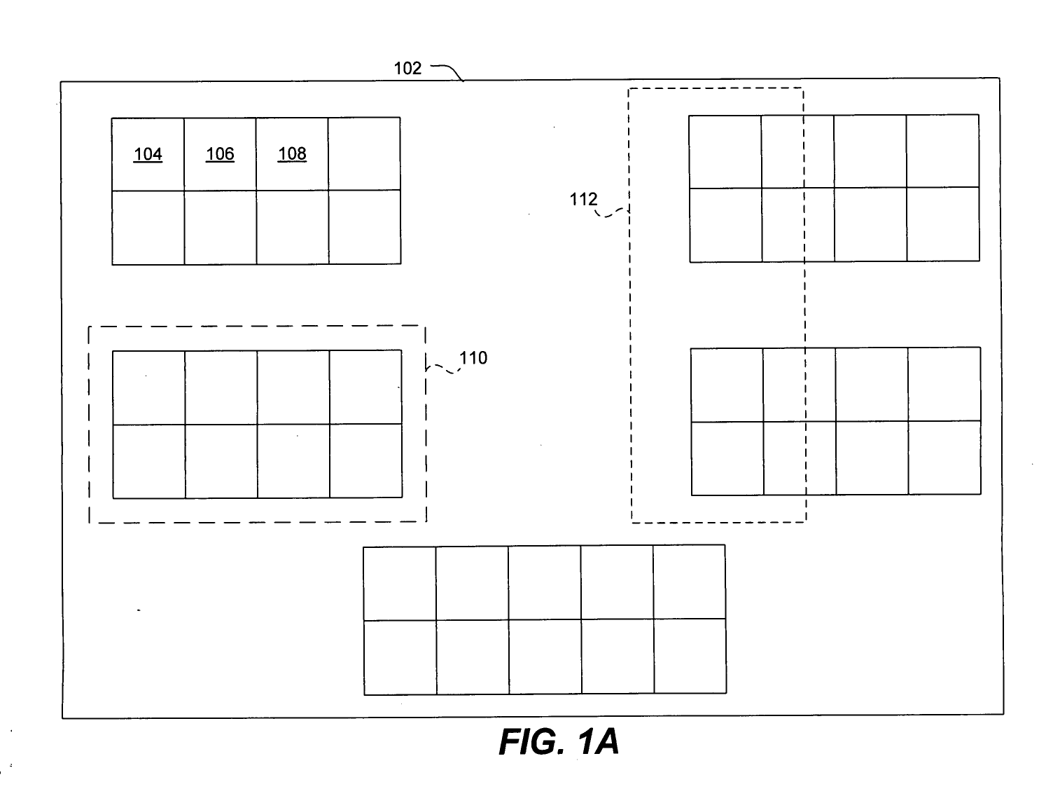

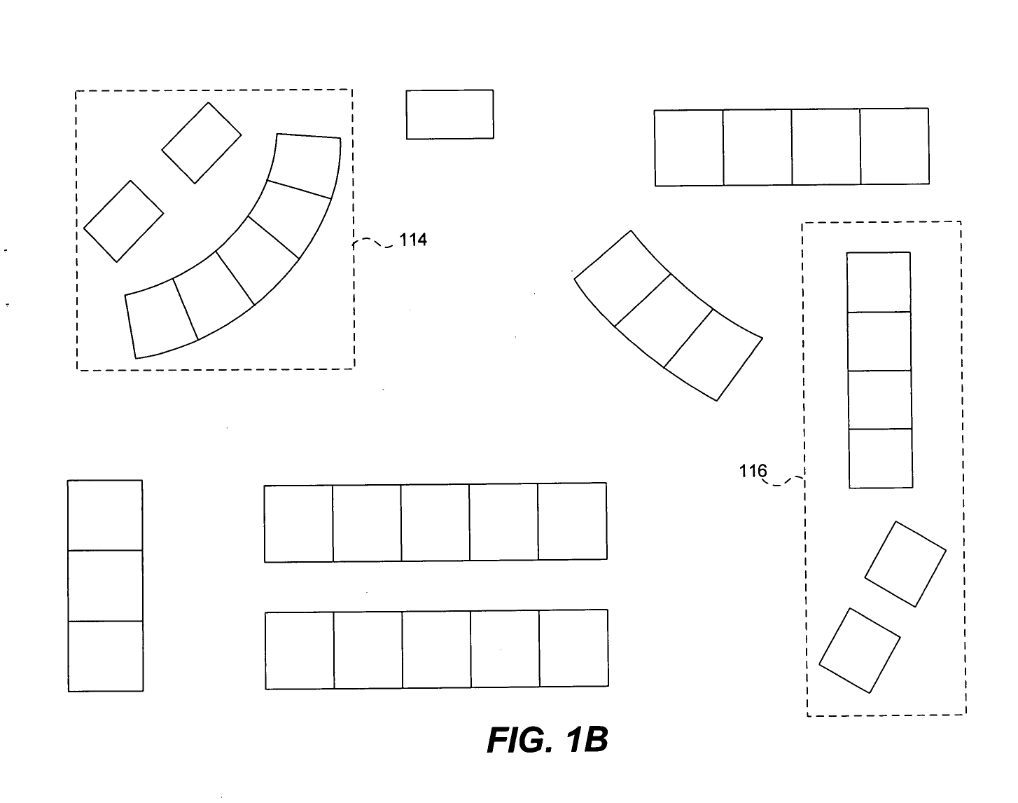

FIG. 1A is a top-view of a gaming machine floor layout showing possible gaming machine zones. A gaming machine layout 102 shows numerous gaming machines 104, 106, 108 and so on. A zone 110 is comprised of machines grouped together in the same bank of machines. Another zone 112 contains gaming machines along one end of two gaming machine banks. FIG. 1B is another example gaming machine floor layout in a gaming establishment. A few example zones 114 and 116 are shown within the dashed lines. As can be seen from the examples shown in FIGS. 1A and 1B, there can be many various configurations of gaming machine zones. The most suitable zone configuration may be determined, at least in part, by the power consumption control needs of a gaming operator. A gaming operator can uniformly control power supplied to all gaming machines in the same zone. For example, using the control system of the present invention, a gaming operator can turn off all the hoppers and printers of some or all gaming machines in the same zone. As described in detail below, a gaming machine has numerous components, such as displays, lights, coin acceptors, disk drives, bill acceptors, printers, card readers, motor controller, and light controller and so on. Generally, each component consumes power. In a preferred embodiment, the power consumption control system of the present invention controls power consumption of a gaming machine by controlling the power provided to its components, rather than by “pulling the cord” on the entire machine, that is, by cutting off power to the entire gaming machine.

As described in greater detail below, in a preferred embodiment, specific gaming machine components are powered on or off depending on historical usage data and activity levels as well as on specific, unpredictable actions taken on a specific machine by users or potential users, such as inserting a card or bill, approaching a machine, or pausing by a machine.

One set of data utilized by the power control system to control power consumption can be characterized as activity or activity usage pattern data. As described in greater detail below, historical and statistical data on usage of gaming machines in a zone, on individual gaming machines, and on components of a machine may be used to derive intelligence on when to preemptively ‘turn down’ the energy to “cold” zones in a gaming establishment.

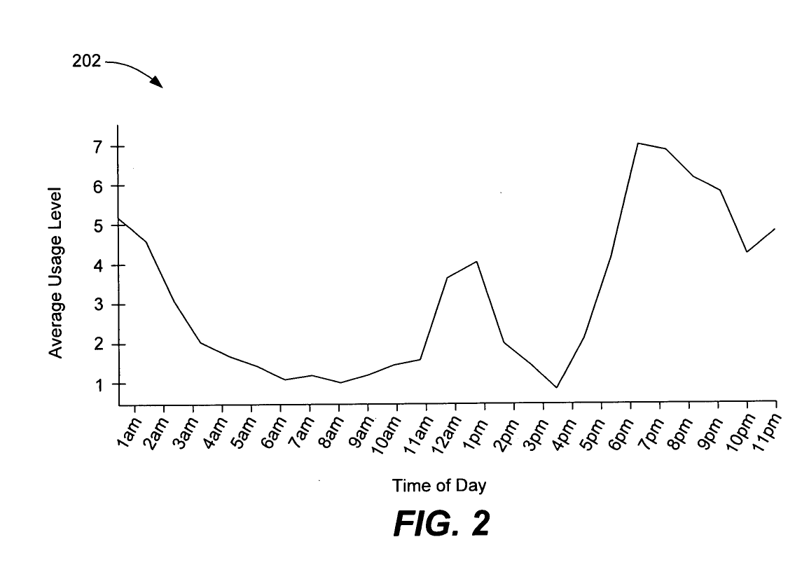

In a preferred embodiment, raw activity data for a zone of gaming machines are collected and tabulated. In an alternative embodiment, the same data can be collected for a specific gaming machine and for specific components in a gaming machine. FIG. 2 is a sample graphical representation showing average usage levels of gaming machines in a zone. Shown is a graph 202 with average usage levels of machines in the zone shown on the vertical axis and hourly time increments shown on the horizontal axis. For example, the average usage level of gaming machines in the zone represented by graph 202 is highest between 6 and 7 pm. The usage data and patterns of each zone of a gaming establishment can be examined to derive a “heat map” of the casino floor, where “heat” refers to activity on gaming machines in each zone, to the number of patrons in a zone within predetermined time intervals, or to other such metrics. The type of raw activity usage data gathered for a gaming machine includes, to name a few examples, winnings, payouts, most common and least common selected denominations, the number of bills and coins accepted every x minutes, the number of card reads every y minutes, the number of patrons detected in the vicinity of a gaming machine during a predetermined time interval and so on. According to some implementations of the invention, zones may be determined in an ad hoc manner, according to activity levels or other such measures of “heat,” rather than defining zones in advance and then determining activity levels in the previously-defined zones. Still other implementations of the invention allow zones to be arbitrarily defined, but also allow such zones to be updated according to observed patterns of patron activity or the like.

Software tools are available that are proficient at measuring and analyzing gaming machine usage and creating heat maps which gaming operators can use, for example, to re-configure and optimize casino floors for better gaming activity, to identify games, game themes, and wager gaming machines that are not attracting users, and so on. For example, Compudyne, Inc. of Annapolis, Md., makes such a product. However, as is known in the field of wager gaming networks, a gaming operator can obtain activity and usage data for a particular machine by sending certain native commands to a machine. Thus, third-party activity measuring tools are not necessary to implement the present invention.

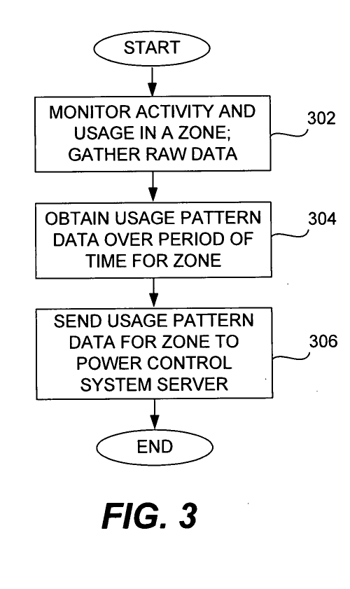

Although these activity data can be used to derive heat maps, when collected over a period of time these data can also provide a history of usage for gaming machines in a zone or for a specific machine. As described in detail below, this history of usage can be used to derive usage patterns that are used as one factor in controlling the power supplied to a gaming machine's components. FIG. 3 is an overview flow diagram of a process of obtaining usage pattern data in accordance with one embodiment of the present invention. Steps of the methods shown and described need not be performed (and in some implementations are not performed) in the order indicated. Some implementations of these methods may include more or fewer steps than those described. At step 302 a gaming operator measures activity and usage of gaming machines in a zone, thereby obtaining unprocessed activity data for that zone. In another embodiment, the activity data measured are for individual gaming machines. The granularity of the data can be adjusted to suit the needs of the gaming operator. In a simple example, shorter time intervals between measurements and fewer machines in each zone will enable a gaming operator to perform more refined tuning of the power consumption control system of the present invention. Increasing the number of metrics would also increase the level of control. As noted above, the raw data can be gathered using external tools, gaming machine commands, or a combination of both.

At step 304 the raw activity data collected for a period of time are examined to obtain usage patterns. Although the time period can vary, one of the purposes of collecting the raw data is to have a statistically meaningful body of activity data so that when examining the accumulated historical data, useful and accurate usage patterns can be identified. It is estimated that generally such patterns may be discernable in the wager gaming machine context from about four to six weeks of collected activity data. Many factors can influence this, such as time of year, special events, changes in gaming floor environment, and so on. Data thus acquired may be analyzed and/or aggregated in any convenient fashion. These raw data can be analyzed for patterns by human beings or by using suitable pattern-identifying software tools that can be used alone or in combination with analysis by individuals. In some implementations, data from individual gaming machines are used to determine activity zones or the like. For example, such data may be plotted on a map and contoured to establish activity zones.

At step 306 pattern data are sent to a power control system server or other suitable network server capable of executing a power control system process, where they are stored or from where the data can be accessed and managed. In a preferred embodiment, a power control system server, described in greater detail below, can be referred to as a global power controller for gaming machines. In the embodiment where raw data are measured only for a specific gaming machine, the pattern data can be stored on the gaming machine or on both the gaming machine and the power control system server. In one embodiment, usage pattern data for a specific machine are stored on that machine thereby eliminating the need to rely on an external network component, such as the power server, to regulate the gaming machine's own power consumption.

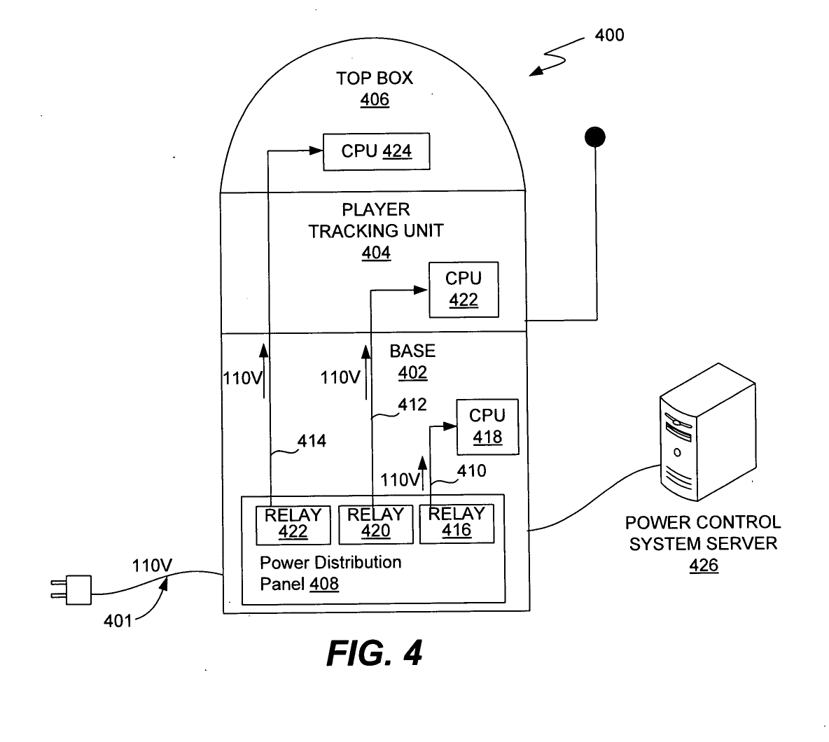

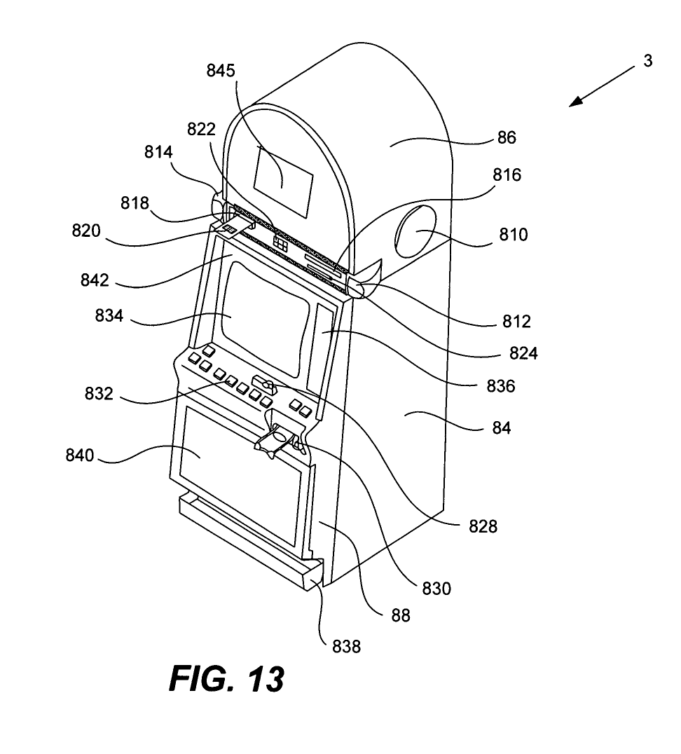

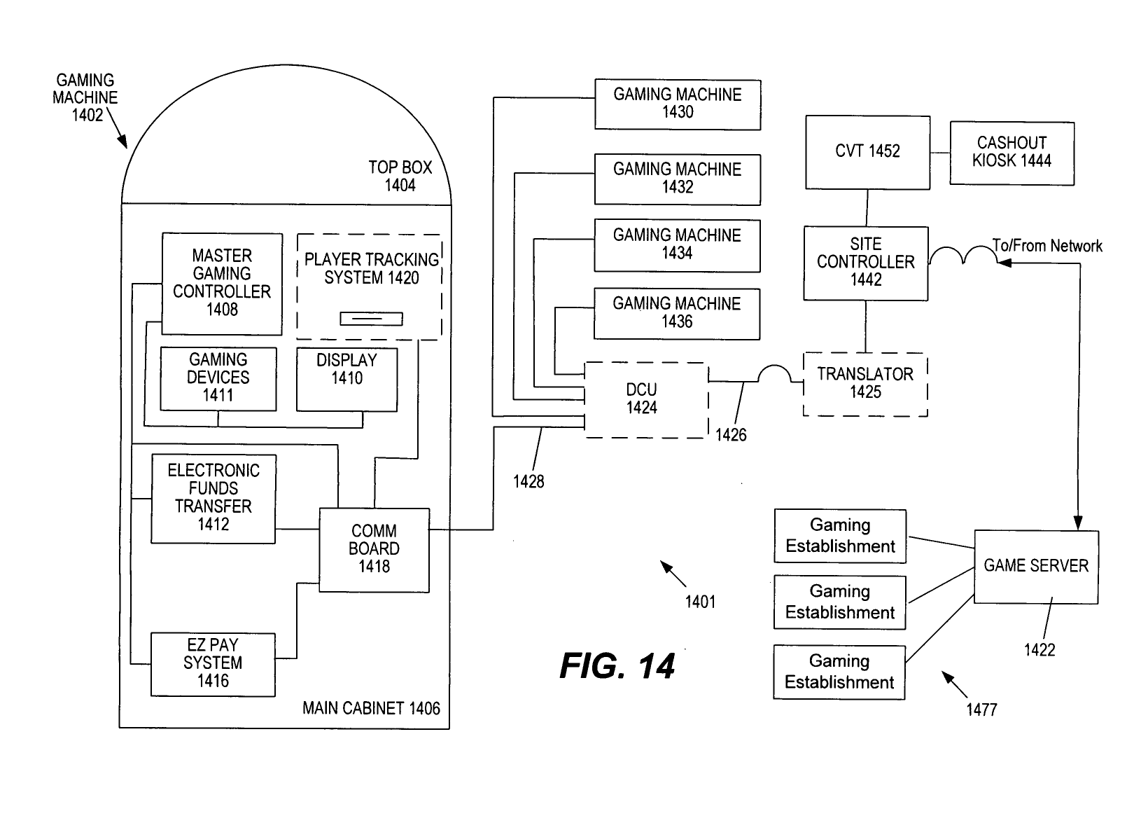

It is useful at this point to describe gaming machine hardware and power-related devices as they relate to the power control system of the present invention. Such devices are shown in FIG. 4. A more detailed description of a wager gaming machine is also provided below with reference to FIGS. 13 and 14. An electronic gaming machine 400 is connected via cord 401 to a power source, such as a 110 v A/C output. The voltage necessary to operate machine 400 can vary according to the geographic location of gaming machine 400. Techniques for addressing out-of-tolerance voltages, such as having tighter voltage margins, are discussed below with reference to FIG. 13. A gaming machine can have multiple segments. In exemplary machine 400 there are three segments: a base 402, a player tracking unit 404, and a top box 406. In other embodiments, these segments can be referred to using different terms, can perform functions different from those described, or can be combined (e.g., player tracking unit may be included in the top box). Power is supplied to machine 400 via connection 401 and is initially received by a power distribution panel 408.

Electrical power is distributed from panel 408 to segments 402, 404, and 406 of gaming machine 400. In exemplary gaming machine 400, three electrical connections, 410, 412, and 414, originate from power distribution panel 408 to three CPUs, via relays, providing power to the CPUs. Electrical connection 410 transmits current via relay 416 to base CPU 418. Similarly, electrical connection 412 transmits current via relay 420 to CPU 422 of player tracking segment 404 and connection 414 transmits current via relay 422 to CPU 424 of top box 406. In another embodiment, power distribution panel 408 is on a power control system server 426 which distributes power to the various gaming machine components. In other embodiments, there can be more or fewer CPUs or CPU-related components in gaming machine 400 that receive power from distribution panel 408. In yet other embodiments, power can be supplied directly from an external power source to a CPU or other gaming machine component so that power is not supplied through distribution panel 408.

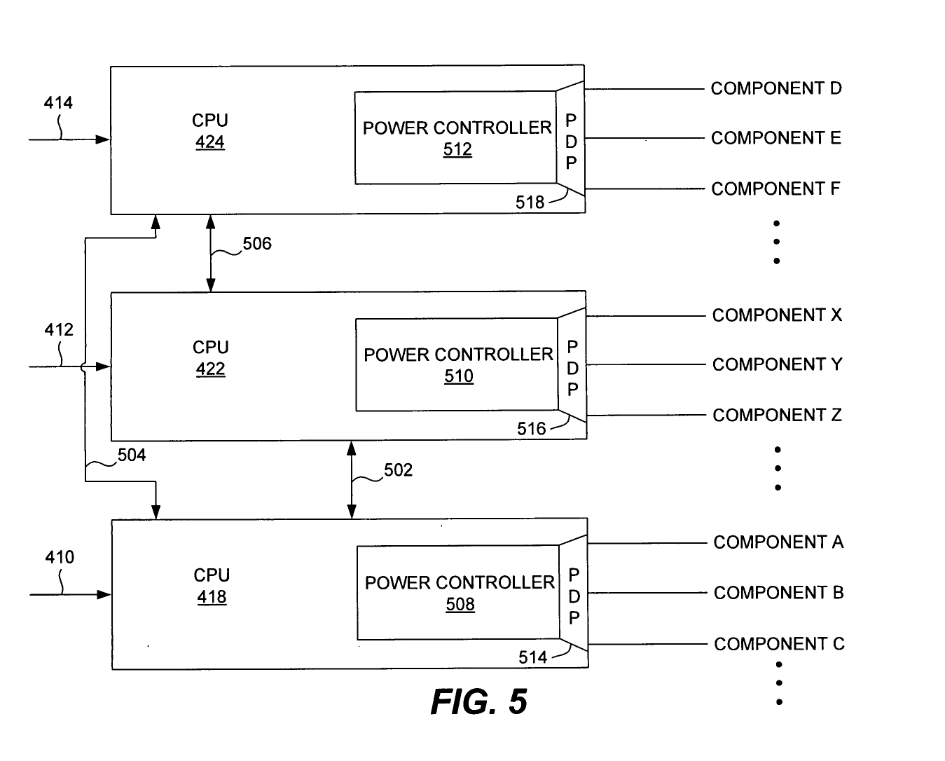

FIG. 5 is a block diagram showing details of CPUs 418, 422, and 424 and distribution of power to components in accordance with one embodiment of the present invention. In one implementation of gaming machine 400, CPUs 418, 422, and 424 communicate with each other. CPU 418 and 422 are connected via a connection 502 which can be, for example, a USB connection or an Ethernet connection. CPU 418 and 424 are connected via connection 504 and CPUs 422 and 424 are connected via connection 506. In a preferred embodiment, CPUs 418, 422, and 424 control operation of one or more gaming machine components, each of which consume power. For example, base CPU 418 can control numerous components including a printer, bill and coin acceptors, lights, a hopper, displays, disk drives, among other components. These components are represented generically as components A, B, C, and so forth in FIG. 5. With respect to player tracking unit CPU 422, exemplary components include a card reader, printer, display, and disk drives, shown in FIG. 5 as components X, Y, Z, and so on. With top box CPU 424, components under its control may include a light controller, displays, and a motor controller. It will be appreciated that these components are illustrative and that a particular CPU can have under its control more or fewer components and peripherals than those listed.

Also shown in FIG. 5 are three power controllers 508, 510, and 512, each operating in conjunction with CPU 418, 422, and 424, respectively. In a preferred embodiment a power controller, described in greater detail below, is embedded on a CPU board. In other embodiments, a power controller is implemented as a software module or as a separate hardware component that is operatively coupled with the CPU. Also shown in FIG. 5 are three CPU-level power distribution panels, 514, 516, and 518 each of which distribute power to the components. As is known in the art, power distribution panels 408 (gaming machine-level), 514, 516, and 518, can be seen as “crowbars” that provide or cut off power to a CPU, component, etc. often according to power-related commands or signals it receives. In another embodiment, a single power controller can be used in conjunction with two or more CPUs (and their associated components) by utilizing communication lines 502, 504, and 506. In another preferred embodiment, a power controller can reside on power control system server 426 or other network server, such as a server-based gaming (“SBG”) server.

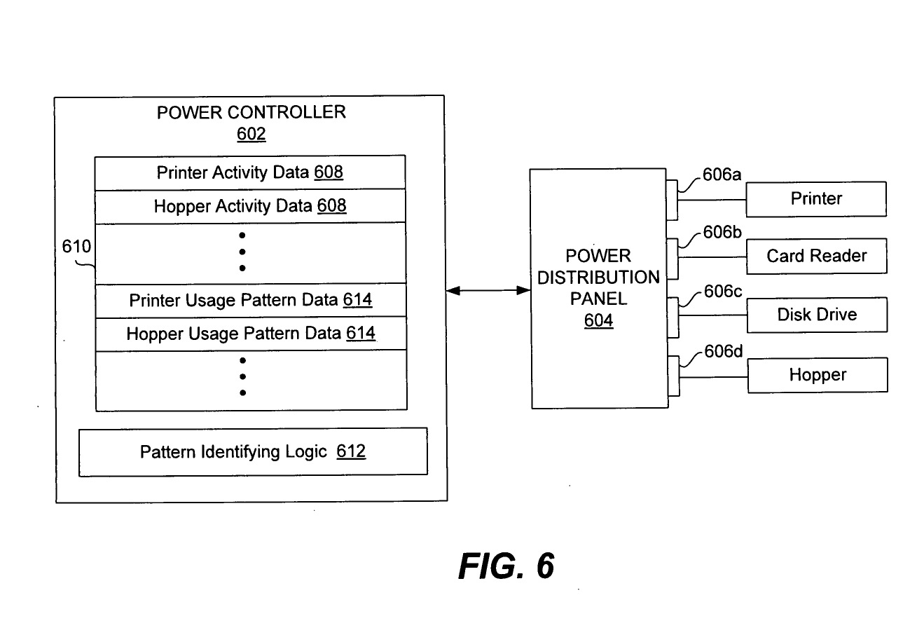

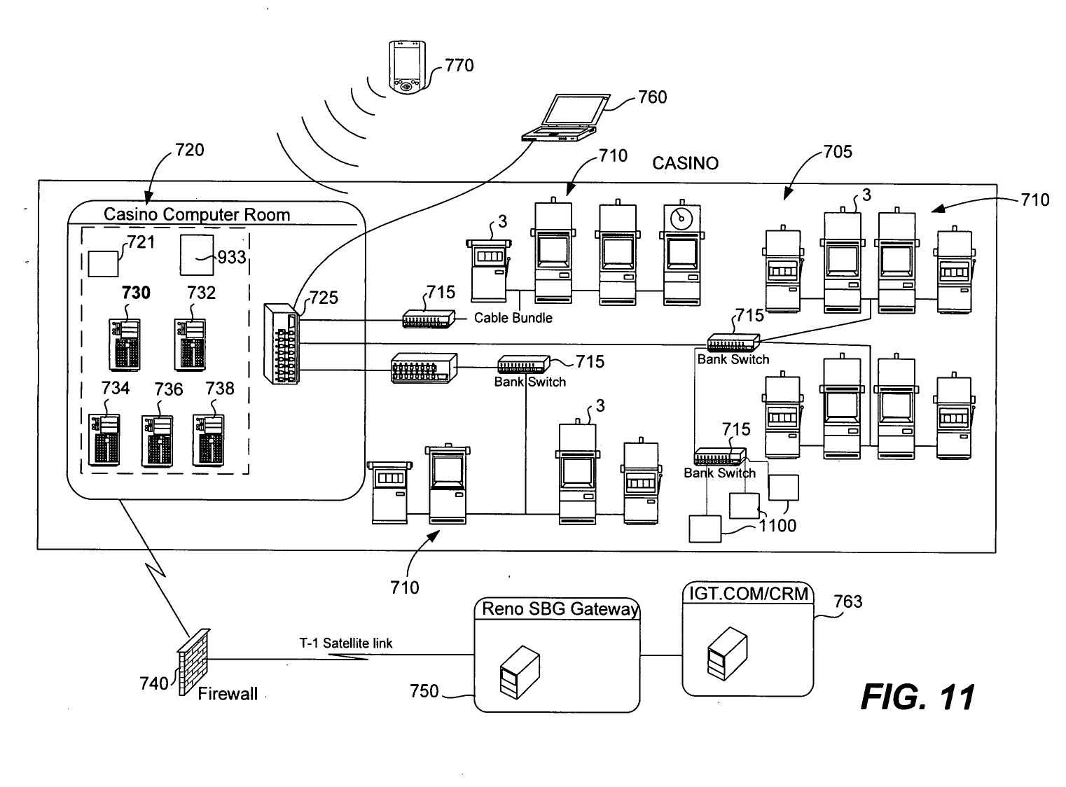

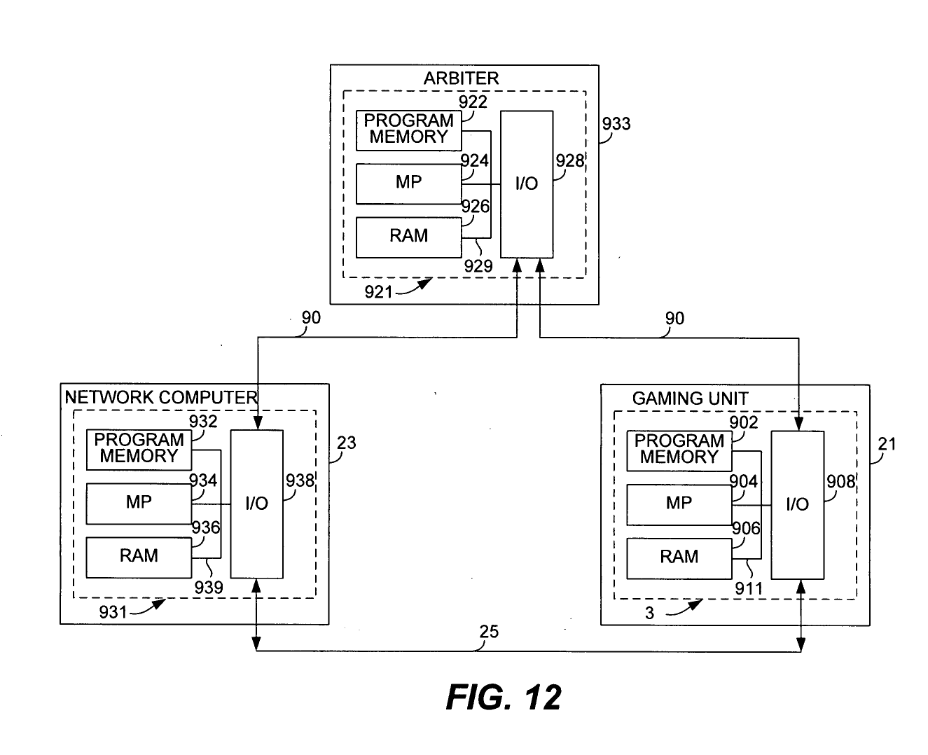

FIG. 6 is a block diagram showing a power controller and a power distribution panel for a CPU, which further illustrates controllers 508, 510, and 512 of FIG. 5. A power controller 602 operates in conjunction with a power distribution panel 604 with ports 606a, 606b . . . to communicate with various gaming machine components. In a preferred embodiment, power controller 602 monitors and records the usage of components controlled by its associated one or more CPUs (not shown). For instance, power controller 508 for base CPU 418 monitors and stores the activity and usage of all or some of the components under control of base CPU 418. In one example, with respect to a printer, a power controller may record that the printer was activated and printed a ticket 10 times in a 24-hour period or printed a ticket seven times from 8 to 10 pm, and so on. It may also record the time the tickets were printed and other metrics. The frequency and granularity of the data being recording can be set by the gaming operator. In a preferred embodiment, monitoring of component usage is constant. Power controller 602 can also reside on a power control server or other network server and still perform monitoring and storage activities described via the gaming network as shown in FIGS. 11 and 12.

Raw usage data 608 are stored under control of power controller 602 in usage data storage area 610. Thus, in a preferred embodiment, a power controller monitors and stores raw usage data for all or some of the components controlled by the one or more associated CPUs. In this manner, in a preferred embodiment, power controllers 508, 510, and 512 create and store a body of raw data for each of the gaming machine components A, B, C . . . , X, Y, Z . . . , and so on.

In a preferred embodiment, power controller 602 examines the raw usage data 608 to identify usage patterns for a component. For example, power controller logic 612 or external software under its control examines raw data 608 for a statistically meaningful time period and stores usage pattern data 614 in storage area 610 or in a separate area accessible by power controller 602. In some embodiments, usage pattern data 614 are transmitted to power control system server 426 or both usage data 608 and usage pattern data 614 are transmitted to server 426. In other embodiments, these data or portions thereof may initially be stored and thus already reside on server 426 or other network server, such as an SBG server.

Logic 612 or other software tools necessary for analysis of raw data 608 to identify usage patterns can be developed by the gaming operator or can be a third-party software tool executed by the power controller's associated CPU. In a preferred embodiment usage pattern data 614 are transmitted to power control system server 426 where they are used as one factor in the power control system of the present invention. In another embodiment, raw usage data 608 are transmitted to server 426 and usage pattern analysis is performed on server 426 rather than on the gaming machine. In another embodiment, the analysis is distributed among gaming machine 400, server 426, and other gaming network servers.

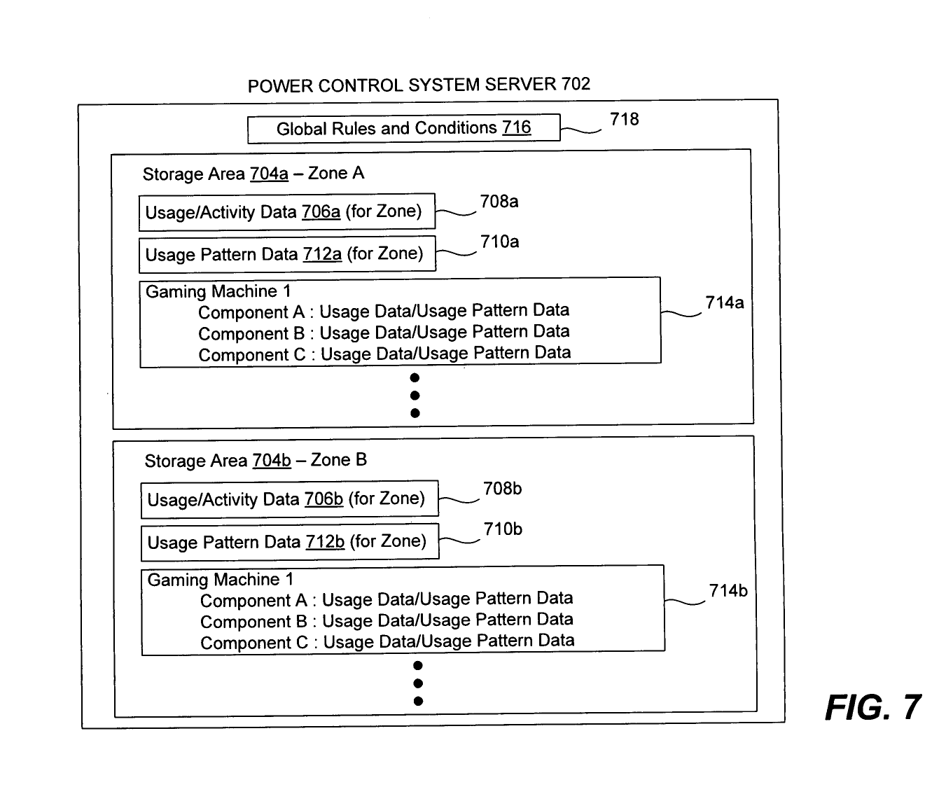

As described above, gaming machines on a casino floor can be divided into zones wherein a zone is comprised of gaming machines having at least one common feature such as being in proximity to one another. In a preferred embodiment, power control system server, such as server 426, organizes its data based on gaming machine zones. FIG. 7 is diagram showing data components and their organization on a power control server in accordance with one embodiment of the present invention. At a high level, data on a server 702 are arranged based on zones. Storage area 704a stores data for one zone, such as zone A, storage area 704b stores data for zone B, and so on. The various zones do not have to be at the same gaming establishment. Server 702 can store and analyze data from zones at different physical gaming establishments are operated by one gaming operator or by different gaming operators where server 702 is under control of a third-party power control service provider. Thus, server 702 can be shared by more than one gaming operator where the gaming operators share the same goal of gaming machine power management. In another embodiment, all or some of the data components and software described can reside on another suitable network server.

In a preferred embodiment, storage areas 704a, 704b, etc. each store overall usage and activity data 706a, b . . . for the gaming machines in a zone in storage areas 708a,b . . . . As described above, these data can be derived from the gaming operator or from third-party software tools used to create “heat maps” of a casino floor. Storage areas 710a,b . . . each store usage pattern data 712a, b . . . for gaming machines in a zone. These data can be organized and stored in many different configurations and data schemas. Storage areas 714a, b . . . store usage data and pattern data for components for each gaming machine in a zone. In one configuration, usage pattern data for each component of a single gaming machine are stored together. In another configuration, usage pattern data for a single component, such as a printer, for all gaming machines in a zone are stored together. As is well known in the field of programming, the usage pattern data combined with the raw usage activity data can be stored as objects in an object oriented model or as a collection of relational database tables. Several other data storage and management implementations are possible. The data arrangement of FIG. 7 is only one high-level example. As described in greater detail below, storage area 718 of server 702 stores rules and conditions 716 that are examined to determine power supply to gaming machine in a zone.

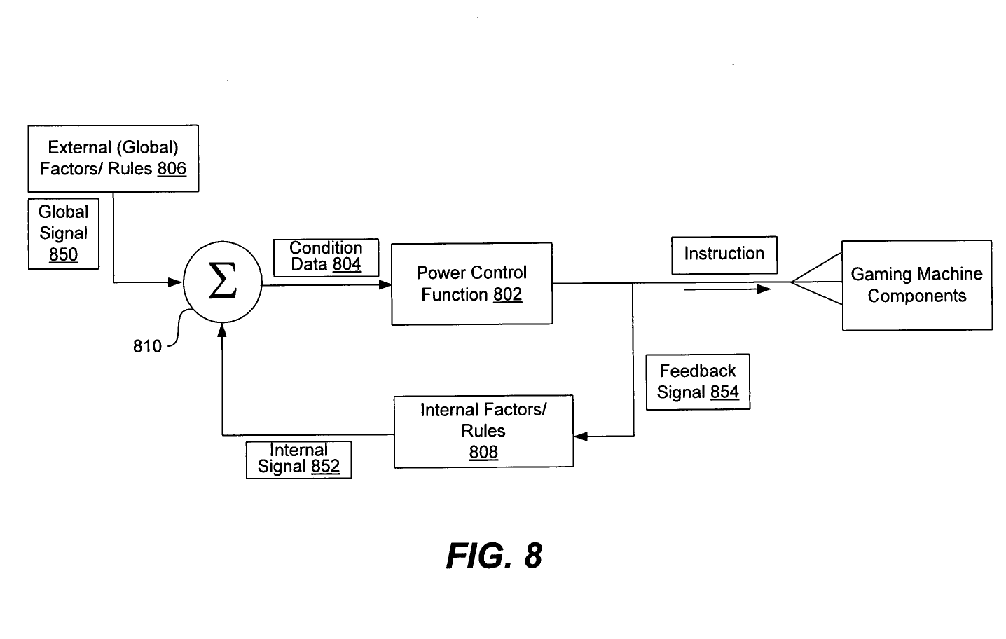

FIG. 8 is a diagram of a power control process for processing rules and conditions relating to power consumption by components of a gaming machine in accordance with one embodiment of the present invention. In a preferred embodiment power control function 802 executes on a gaming machine (not shown). In a preferred embodiment, a power control function 802 accepts as input, condition data 804 that are a combination of data from an external source 806 and an internal source 808. In another embodiment, the power control process executed in a power controller resides on server 702, an SBG server or other suitable network server. An output from power control function 802 is one or more instructions to take action with respect to powering up or powering down gaming machine components.

In a preferred embodiment, external source 806 is power control system server 702. To describe the input from server 702, it is useful to start with the concept of gaming machine zones. As described earlier, usage patterns are derived for a gaming machine zone from unprocessed activity data from the gaming machines in that zone. Thus, certain high-level rules based on the usage patterns can be formulated for gaming machines in a particular zone. In a preferred embodiment, these rules can be categorized as temporal, spatial, event-based, or as combinations thereof. Based on the usage history of machines in a zone, a zone can be described as a “cold,” “warm,” or “hot” zone, depending on the day of the week (temporal), time of day (temporal), location (spatial), among other factors. In another embodiment, these characterizations and rules can be applied to an individual gaming machine rather than to a zone of machines. Moreover, there may be more or fewer than three activity levels. In some implementations there may be gradations within one or more of the cold, medium or hot levels. Such gradations may be based on one or more factors or factor types.

For example, in some implementations a gaming machine and/or a zone may be classified according to one of various default levels of “hotness” (e.g., from level A through level E) according to spatial factors, such as traffic patterns, historical gaming machine usage patterns, etc., in a gaming establishment. In one such example, a gaming machine may be assigned a spatial category of “A” because it is located in a high-traffic area. As described in more detail elsewhere herein, this level of hotness may correspond with a default level of readiness at which one or more components of a gaming machine may be maintained. However, the assigned level of hotness may depend on other factors, such as temporal factors. For example, a hotness level of 1 through 5 may be assigned to a gaming machine according to the time of day, the day of the week, etc. In some such implementations, the default hotness level can be a combination of more than one factor. Accordingly, the previously-referenced gaming machine may have a default hotness level ranging from A1 (here, the “hottest” level) to A5, depending on temporal factors. Other factors may be combined in a similar fashion. Some implementations allow a factor to be weighted or biased, such that its effect is greater than that of one or more other factors.

There are various examples that can be used to illustrate these rules, characterizations, and concepts. Many of them are likely to be based on temporal factors, such as: If the time is 3 am and the day is Tuesday, then send a global signal 850 to all machines in zone B to power down components A, B, and C. Alternatively, global signal 850 may indicate that one or more components should be kept in a lower state of readiness, such as a “sleep” mode or a “stand-by” mode. This rule may have been derived based on historical usage patterns, suggesting that machines in zone B are used infrequently at that time and day, and it is not energy efficient to keep components, such as ticket printers, lights, bill validators, and the like, at a constant state of readiness. In another temporal example, if the time is 9 pm and the day is Saturday, keep all components in all machines in all zones powered and at a constant state of readiness. A gaming operator can collect raw activity data at a granular level (e.g., every 15 minutes) or at a broader, coarser level to derive usage patterns.

In a spatial example, if a gaming machine is taken from a first location where there was little patron traffic to a second location where the traffic is high, thereby presumably changing the zone that the machine is in, the rules regarding that machine's state of readiness will be adjusted to reflect its new high-traffic location. Therefore, if the time is 6 pm and the day is Friday, at the first location, certain components are powered down because of only occasional traffic in the area (a “warm” zone). At the same time and day in the new location, only one component is powered down because of the higher traffic in its new “hot” zone. In a preferred embodiment, the global, external rules are zone based. Thus, in the preceding example, all other machines in the “hot” zone also have only one component powered down. As can be seen, there are numerous variations and possibilities of externally supplied, global rules and factors 806. Many, but not all, can be abstracted to a time/place conditional statement: If it is X time of day, on Y day, and machine is in Zone C, power down the following machine components. Or, machines in Zone B should never power down any components. In another example, a machine may be a stand-alone machine or placed at a location that is not part of a zone (e.g., for a special event), in which case the rules for the machine will take into account special circumstances such as times when the machine cannot be used (e.g., store hours or special event hours), and the like.

External, global input signal 850 described above is combined with an internal signal 852 from internal factors/rules module 808, where internal signal 852 originates from the gaming machine. Internal signal 852 represents an essentially unpredictable action that is taken on the gaming machine by a user or potential user. Signal 852 can also represent some effect on a gaming machine resulting from the machine's immediate environment or surroundings. In the embodiment where the power controller is on a server, the server receives internal signal 852 in close to real time so the power controller can act on the signal immediately thereby keeping any latency detectable by a user to a minimum. In a preferred embodiment, external, global signal 850 from server 702 is generally constant. There will likely always be some rule and resulting signal 850 for the time, day, and zone placement of a machine. Although it is possible that there is no global rule (perhaps because of insufficient historical data or usage pattern data) in which case, in a preferred embodiment, the machine will remain in a state of full readiness with all components powered on (i.e., the default power state).

Internal input signal 852 is created and transmitted when there is some action taken on or detected by the gaming machine. Some examples of actions taken on a machine include: a bill accepted by a bill validator, a card inserted into card reader, a person sitting on the machine seat, a person approaching the machine, a person pausing near the machine, a player tracking device being inserted, pressing any button on the machine, pulling the handle, inserting a coin, and so on. Some of these actions or events may require additional mechanisms for the machine, such as motion detectors and other sensors such as IR or optical detectors, ultrasonic detectors, or Webcams to detect when people pause in the area near a machine. The number of local factors is limited only by the capabilities of the gaming machine and the supplemental mechanisms and devices a gaming operator wants to have associated with the machine. In a preferred embodiment, a common characteristic of the local factors is that it is independent of other gaming machines or other components in a gaming network. Local factors enable a degree of independent control by a gaming machine over its own power consumption.

A summation or combination component 810 combines external, global signal 850 with internal, local signal 852. A combined signal 804 is input to power control function 802. An example of a combined signal may be (in narrative form): “Power down components 1-8 because it is 2 am and it is a Tuesday (global rule), and a $100 bill has been inserted into the bill validator (local factor)” or “Because it is 6 pm and it is a Sunday, power down components 3 and 4 (global), and the machine has detected motion nearby (local).” From a broader perspective, the global rules, derived primarily from zone-based historical usage patterns, provide a relatively coarse level of control of power consumption by gaming machines, which can be refined or adjusted by changing the frequency of data collection, the number of metrics, and so on. The local factors provide a comparatively fine level of control given that they derive from specific and generally unpredictable actions or events occurring on or near the machine and are independent of other components in a gaming network. In addition, in a preferred embodiment, data relating to these local actions or events, such as internal signal 852, do not need to be pushed or transmitted to power control system server or to any other gaming network component. In another embodiment, it may be desirable to have the local-factor, internal signal 852 processed by power control function 802 on a server.

Control function 802 processes the combined input signal by utilizing programmed intelligence to determine which of the machine's components should be powered on or off. In one scenario, a global rule which may instruct via signal 850 that six of the machines components be powered down may be overridden by a local factor, such as a card read or bill insert (embodied in signal 852). In another scenario, a motion detected in the vicinity of the machine may not be sufficient to override a “power down all components” global signal because it is 4 am and the passing by of one person is not sufficient to power up all the components, whereas an insert of a $100 bill would likely be sufficient. This intelligence can be programmed in the control function in the form of an algorithm, a series of conditional statements, an artificial intelligence (“AI”) program, an object-oriented data model, or any other programming means as known to those skilled in the art. The degree of intelligence or level of sophistication of control function 802 is set by the gaming operator. Generally, response times to local factors need to be quick. That is, a few seconds after a user inserts a card, a bill or coin, a player tracking card, and so on, all the components of the machine should be powered up and ready to operate. There are known methods of distracting a user and “buying time” to allow the gaming machine to achieve a full state of readiness that can be used with the present invention, such as playing a short video clip or other type of animation immediately on powering up to lessen the player's perception of any latency.

In another embodiment, a local factor and internal signal 852 can be seen as a trigger that changes the state of readiness of a gaming machine as determined by a global factor or condition. In this embodiment, the global factor sets the “normal” power consumption of the gaming machine. A local factor can act as a triggering event that can change the normal state of readiness. In this case, the summation step may not be needed in that a local factor that is sufficiently significant to be a trigger will automatically alter the “normal” power consumption of the machine and need not be combined with global signal 850.

However, in a preferred embodiment, control function 802 processes the combined input signal and computes an instruction to immediately power up or power down components in the machine. In a preferred embodiment, control function 802 executes on a power controller in the gaming machine such as power controllers 508, 510, or 512. The instructions to power components in the gaming machine are transmitted to power distribution panels which in turn cut off or supply power to the components.

Control function 802 also generates a feedback signal 854 if it is detected that the gaming machine is still being used. Feedback signal 854 is transmitted to internal factors/rules module 808. The signal qualifies as an internal, local factor (i.e., that the machine is still in use or that at least one of the components is being used). Control function 802 sends a feedback signal 854 to module 808 which determines if the event or action is a local factor. If it is, an internal signal 852 is sent to summation component 810.

In another preferred embodiment of the power consumption control system of the present invention, a single power controller is utilized in a multi-station device, such as a gaming table or carousel with independent wagering stations. For example, a gaming table may have 5 to 10 wager gaming stations, each with its own set of components (often with fewer components than in a normal gaming machine).

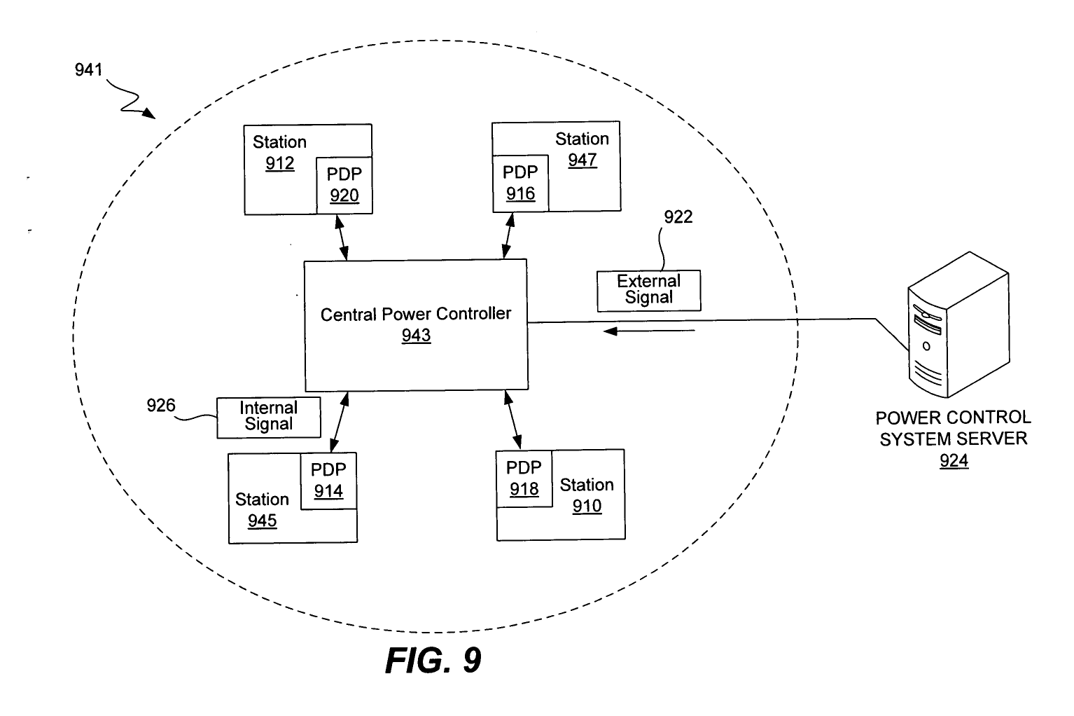

FIG. 9 is a diagram showing relevant power control components in a generic multi-station gaming apparatus connected to a power control system server in accordance with one embodiment of the present invention. A multi-station gaming apparatus 941, such as a gaming table or carousel, has a central power controller 943 connected to four gaming stations 945, 947, 910, and 912, which are independent wagering stations that operate under control of one gaming machine. Each gaming station 945-912 has its own set of components and peripherals (not shown), such as a ticket printer, card reader, bill acceptor, coin hopper, disk drives, and so on. In a preferred embodiment of the present invention, power consumed by each of the components of each gaming station 945 to 912 can be controlled using the methods and components described above, albeit in a different configuration. Each gaming station 945 to 912 has its own power distribution panel 914, 916, 918, and 920. Power controller 943 communicates with each power distribution panel in multi-station device 941 and transmits instructions to each distribution panel to power up or power down components connected to each gaming station 945-912. In a preferred embodiment, power control function 802, executing on power controller 943 processes external, global rules and conditions embodied in an external signal 922 from server 924. As in the preferred embodiment described above, power controller 943 stores raw usage data and usage pattern data for each gaming station 945 to 912. As described in FIG. 8, power control function 802 also receives local, internal signals, such as signal 926, from gaming stations 945 to 912.

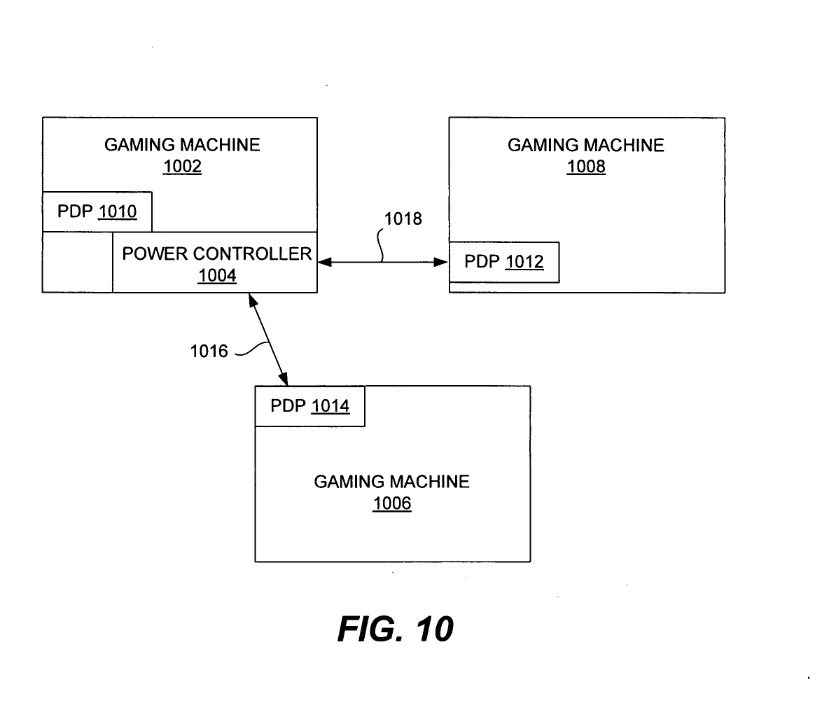

In another embodiment, a power controller operates in a gaming machine controlling the power distribution panel and power consumption of components in that gaming machine, as described in the figures above. The power controller, however, also controls power distribution panels in one or more other gaming machines. This peer-to-peer type configuration is shown in FIG. 10 in which a power consumption control system is implemented by having a gaming machine 1002 with a power controller 1004 in communication with other gaming machines 1006 and 1008 that do not have their own power controller. Each gaming machine has its own power distribution panels (“PDP”) 1010, 1012, and 1014 that are in communication with power controller 1004 in gaming machine 1002, thereby forming a peer-to-peer implementation for controlling power consumption. In this embodiment, although there are fewer power controllers there is a greater need for communication among the gaming machines as shown by lines 1016 and 1018, thus increasing the number of cable connections, wiring, or wireless communication interfaces among gaming machines.

In another preferred embodiment, the power controller is embodied in a type of universal power card that can be inserted or retro-fitted into a gaming machine. A power controller card connects to or “taps” into the necessary communication lines, such as lines 410, 412, and 414 in FIG. 4, so the power controller can monitor activity usage and detect local events and actions. In another embodiment, it communicates directly with a gaming machine's CPUs. A power controller that has its power distribution panel and relays so it can cut power to gaming machine components which connect or “plug into” the distribution panel.

One example of a network topology, which includes network connections between gaming machines in a zone and a power control system server or SBG server, for implementing some aspects of the present invention is shown in FIG. 11. Those of skill in the art will realize that this exemplary architecture and the related functionality are examples and that the present invention encompasses many other such embodiments and methods.

In FIG. 11, a single gaming establishment 705, in this case a casino, is illustrated. However, it should be understood that some implementations of the present invention involve multiple gaming establishments, each of which may have multiple gaming machine zones as described in FIGS. 1A and 1B above. Gaming establishment 705 includes 16 gaming machines 3, each of which is part of a bank 710 of gaming machines 3. In this example, gaming establishment 705 also includes a bank of networked gaming tables 1100, such as the multi-station gaming device described in FIG. 9. It will be appreciated that many gaming establishments include hundreds or even thousands of gaming machines 3 and/or gaming tables 1100, not all of which are included in a bank or gaming machine zone. However, the present invention may be implemented in gaming establishments having any number of gaming machines.

Various alternative network topologies can be used to implement different aspects of the invention and/or to accommodate varying numbers of networked devices. For example, gaming establishments with very large numbers of gaming machines 3 may require multiple instances of some network devices (e.g., of main network device 725, which combines switching and routing functionality in this example) and/or the inclusion of other network devices not shown in FIG. 11. For example, some implementations of the invention may include one or more middleware servers, or the power control system server of the present invention, disposed between gaming machines 3 and server 730. Such middleware servers can provide various useful functions, including but not limited to the filtering and/or aggregation of data received from bank switches 710, from individual gaming machines and from other player terminals. Some implementations of the invention include load balancing methods and devices for managing network traffic.

Each bank 710 has a corresponding bank switch 715, which may be a conventional bank switch. Each bank switch is connected to SBG server 730 via main network device 725, which combines switching and routing functionality in this example. Although various floor communication protocols may be used, some preferred implementations use an open, Ethernet-based SuperSAS® protocol developed by IGT of Reno, Nev. and is available for downloading without charge. However, other protocols such as Best of Breed (“BOB”) may be used to implement various aspects of SBG. IGT has also developed a gaming-industry-specific transport layer called CASH that executes on top of TCP/IP and offers additional functionality and security.

SBG server 730, License Manager 721, Arbiter 933, servers 732, 734, 736, and 738, and main network device 725 are disposed within computer room 720 of gaming establishment 705. Power control system server 702 described in FIG. 7 above may also be located within computer room 720. License Manager 721 may be implemented, at least in part, via a server or a similar device. Some exemplary operations of License Manager 721 are described in detail in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., which is hereby incorporated by reference.

SBG server 730 can be configured to implement, at least in part, various aspects of the present invention. Some preferred embodiments of SBG server 730 and other servers shown in FIG. 11 include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 721, servers 732, 734, 736, and 738, power control system server 702, and main network device 725) are mounted in a single rack with SBG server 730. Accordingly, many or all such devices are sometimes referenced in the aggregate as an “SBG server.” However, in alternative implementations, one or more of these devices is in communication with SBG server 730 but located elsewhere. For example, some of the devices could be mounted in separate racks within computer room 720 or located elsewhere on the network. For example, it can be advantageous to store large volumes of data elsewhere via a storage area network (“SAN”).

In some embodiments, these components of SBG server 730 preferably have an uninterruptible power supply (“UPS”). The UPS may be, for example, a rack-mounted UPS module.

Computer room 720 may include one or more operator consoles or other host devices that are configured for communication with SBG server 730 and with power control system server 702. Such host devices may be provided with software, hardware and/or firmware for implementing various aspects of the invention; many of these aspects involve controlling SBG server 730. However, such host devices need not be located within computer room 720. Wired host device 760 (which is a laptop computer in this example) and wireless host device 770 (which is a PDA in this example) may be located elsewhere in gaming establishment 705 or at a remote location. Such a wireless host device can also include gaming device 20.

Arbiter 933 may be implemented, for example, via software that is running on a server or another networked device. Arbiter 933 serves as an intermediary between different devices on the network. Some implementations of Arbiter 933 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 933 is a repository for the configuration information required for communication between devices on the gaming network (and, in some implementations, devices outside the gaming network). Although Arbiter 933 can be implemented in various ways, one exemplary implementation is discussed below.

FIG. 12 is a block diagram of a simplified communication topology between a gaming unit and machine 21, the network computer 23 and the Arbiter 933. Although only one gaming unit 21, one network computer 23 and one Arbiter 933 are shown in FIG. 7B, it should be understood that the following examples may be applicable to different types of network gaming devices within the gaming network beyond the gaming unit 21 and the network computer 23, and may include different numbers of network computers, gaming security arbiters and gaming units. For example, a single Arbiter 933 may be used for secure communications among a plurality of network computers 23 and tens, hundreds or thousands of gaming units 21. Likewise, multiple gaming security arbiters 46 may be utilized for improved performance and other scalability factors.

Referring to FIG. 12, Arbiter 933 may include an arbiter controller 921 that may comprise a program memory 922, a microcontroller or microprocessor (MP) 924, a random-access memory (RAM) 926 and an input/output (I/O) circuit 928, all of which may be interconnected via an address/data bus 929. Network computer 23 may also include a controller 931 that may comprise a program memory 932, a microcontroller or microprocessor (MP) 934, a random-access memory (RAM) 936 and an input/output (I/O) circuit 938, all of which may be interconnected via an address/data bus 939. It should be appreciated that although the Arbiter 933 and the network computer 23 are each shown with only one microprocessor 924, 934, the controllers 921, 931 may each include multiple microprocessors 924, 934. Similarly, the memory of the controllers 921, 931 may include multiple RAMs 926, 936 and multiple program memories 922, 932. Although the I/O circuits 928 and 938 are each shown as a single block, it should be appreciated that the I/O circuits 928 and 938 may include a number of different types of I/O circuits. RAMs 924 and 934 and program memories 922 and 932 may be implemented as semiconductor memories, magnetically readable memories, and/or optically readable memories, for example.

Although the program memories 922, 932 are shown in FIG. 12 as read-only memories (ROM) 922, 932, the program memories of the controllers 921, 931 may be a read/write or alterable memory, such as a hard disk. In the event a hard disk is used as a program memory, the address/data buses 929, 939 shown schematically in FIG. 12 may each comprise multiple address/data buses, which may be of different types, and there may be an I/O circuit disposed between the address/data buses.

As shown in FIG. 12, the gaming unit 21, such as a reduced power-consumption wager gaming machine of the present invention, may be operatively coupled to the network computer 23 via the data link 25. The gaming unit 21 may also be operatively coupled to the Arbiter 933 via the data link 90, and the network computer 23 may likewise be operatively coupled to the Arbiter 933 via the data link 90. Communications between the gaming unit 21 and the network computer 23 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), game download information (e.g., game software and game licensing information) and personal information (e.g., social security number, personal preferences, etc.) may be encrypted with stronger encryption techniques such as DES or 3DES to provide increased security.

As disclosed in further detail in the Arbiter Application, Arbiter 933 may verify the authenticity of each network gaming device. Arbiter 933 may receive a request for a communication session from a network device. For ease of explanation, the requesting network device may be referred to as the client, and the requested network device may be referred to as the host. The client may be any device on the network 705 and the request may be for a communication session with any other network device. The client may specify the host, or the gaming security arbiter may select the host based on the request and based on information about the client and potential hosts. Arbiter 933 may provide encryption keys (session keys) for the communication session to the client via the secure communication channel. Either the host and/or the session key may be provided in response to the request, or may have been previously provided. The client may contact the host to initiate the communication session. The host may then contact Arbiter 933 to determine the authenticity of the client. Arbiter 933 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, Arbiter 933 may contact the host regarding the request and provide corresponding session keys to both the client and the host. Arbiter 933 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Wireless devices are particularly useful for managing a gaming network. Such wireless devices could include, but are not limited to, laptops, PDAs, tablet PCs, or even cellular telephones. Referring once again to FIG. 11, one or more network devices in gaming establishment 705 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, etc., while on the casino floor.

If a host device is located in a remote location, security methods and devices (such as firewalls, authentication and/or encryption) should be deployed in order to prevent the unauthorized access of the gaming network. Similarly, any other connection between gaming network 705 and the outside world should only be made with trusted devices via a secure link, e.g., via a virtual private network (“VPN”) tunnel. For example, the connection between SBG 730, firewall 740, gateway 750 and central system 763 (here, IGT.com) that may be used for game downloads, etc., is advantageously made via a VPN tunnel.

An Internet-based VPN uses the open, distributed infrastructure of the Internet to transmit data between sites. A VPN may emulate a private TCP/IP network over public or shared infrastructures. A VPN that supports only IP traffic is called an IP-VPN. VPNs provide advantages to both the service provider and its customers. For its customers, a VPN can extend the IP capabilities of a corporate site to remote offices and/or users with intranet, extranet, and dial-up services. This connectivity may be achieved at a lower cost to the gaming entity with savings in capital equipment, operations, and services. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes.

There are many ways in which IP VPN services may be implemented, such as, for example, Virtual Leased Lines, Virtual Private Routed Networks, Virtual Private Dial Networks, Virtual Private LAN Segments, etc. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

As mentioned elsewhere herein, U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., describes novel methods and devices for authentication, game downloading and game license management. This application has been incorporated herein by reference.

Providing a secure connection between the local devices of the SBG system and IGT's central system allows for the deployment of many advantageous features. For example, a customer (e.g., an employee of a gaming establishment) can log onto an account of central system 763 (in this example, IGT.com) to obtain the account information such as the customer's current and prior account status.

Moreover, such a secure connection may be used by the central system 763 to collect information regarding a customer's system. Such information includes, but is not limited to, error logs for use in diagnostics and troubleshooting. Some implementations of the invention allow a central system to collect other types of information, e.g., information about the usage of certain types of gaming software, revenue information regarding certain types of games and/or gaming machines, etc. Such information includes, but is not limited to, information regarding the revenue attributable to particular games at specific times of day, days of the week, etc. Such information may be obtained, at least in part, by reference to an accounting system of the gaming network(s), as described in U.S. patent application Ser. No. 11/225,407 (Attorney Docket No. IGT1P237/P-1051), by Wolf et al., entitled “METHODS AND DEVICES FOR MANAGING GAMING NETWORKS,” which has been incorporated herein by reference.

Automatic updates of a customer's SBG server may also be enabled. For example, central system 763 may notify a local SBG server regarding new products and/or product updates. For example, central system 763 may notify a local SBG server regarding updates of new gaming software, gaming software updates, peripheral updates, the status of current gaming software licenses, etc. In some implementations of the invention, central system 763 may notify a local SBG server (or another device associated with a gaming establishment) that an additional theme-specific data set and/or updates for a previously-downloaded global payout set are available. Alternatively, such updates could be automatically provided to the local SBG server and downloaded to networked gaming machines.

After the local SBG server receives this information, it can identify relevant products of interest. For example, the local SBG server may identify gaming software that is currently in use (or at least licensed) by the relevant gaming entity and send a notification to one or more host devices, e.g., via email. If an update or a new software product is desired, it can be downloaded from the central system. Some relevant downloading methods are described elsewhere herein and in applications that have been incorporated herein by reference, e.g., in U.S. patent application Ser. No. 11/078,966. Similarly, a customer may choose to renew a gaming software license via a secure connection with central system 763 in response to such a notification.

Secure communication links allow notifications to be sent securely from a local SBG server to host devices outside of a gaming establishment. For example, a local SBG server can be configured to transmit automatically generated email reports, text messages, etc., based on predetermined events that will sometimes be referred to herein as “triggers.” Such triggers can include, but are not limited to, the condition of a gaming machine door being open, cash box full, machine not responding, verification failure, etc.

In addition, providing secure connections between different gaming establishments can enable alternative implementations of the invention. For example, a number of gaming establishments, each with a relatively small number of gaming machines, may be owned and/or controlled by the same entity. In such situations, having secure communications between gaming establishments makes it possible for a gaming entity to use a single SBG server as an interface between central system 763 and the gaming establishments.

FIG. 13 is a perspective view of an electronic wager gaming machine, also described in FIG. 4 showing the various power-related devices, such a power controllers and power distribution panels. Components and modules of a gaming machine 3 may have equivalents in a mobile gaming device. For example, a mobile gaming device may have a software-enabled module equivalent of a physical component in gaming machine 3. In some cases, components of machine 3 such as coin hoppers, coin tray, and bill validator, are not needed or not practicable to include with a mobile gaming device. Gaming machine 3 includes a main cabinet 84, which generally surrounds the machine interior (not shown) and is viewable by users. The main cabinet includes a main door 88 on the front of the machine, which opens to provide access to the interior of the machine. Attached to the main door are player-input switches or buttons 832, a coin acceptor 828, and a bill validator 830, a coin tray 838, and a belly glass 840. Viewable through the main door is a video display monitor 834 and an information panel 836. The display monitor 834 will typically be a cathode ray tube, high resolution flat-panel LCD, or other conventional electronically controlled video monitor. The information panel 836 may be a back-lit, silk screened glass panel with lettering to indicate general game information including, for example, a game denomination (e.g. $0.25 or $1). The bill validator 830, player-input switches 832, video display monitor 834, and information panel are devices used to play a game on the game machine 3. The devices are controlled by circuitry (e.g., the master gaming controller) housed inside the main cabinet 84 of the machine 3.

As described above, many different types of games, including mechanical slot games, video slot games, video poker, video black jack, video pachinko and lottery, may be provided with gaming machines of this invention. In particular, the gaming machine 3 may be operable to provide play of many different instances of wagering games of chance. The instances may be differentiated according to themes, sounds, graphics, type of game (e.g., slot game vs. card game), denomination, number of paylines, maximum jackpot, progressive or non-progressive, bonus games, etc. The gaming machine 3 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

As described in FIG. 4 above, wager gaming machine 3 includes a top box 86, which sits on top of the main cabinet 84. The top box 86 houses a number of devices, which may be used to add features to a game being played on the gaming machine 3, including speakers 810, 812, 814, a ticket printer 818 which prints bar-coded tickets 820, a key pad 822 for entering player tracking information, a florescent display 816 for displaying player tracking information, a card reader 824 for entering a magnetic striped card containing player tracking information, and a video display screen 845. The ticket printer 818 may be used to print tickets for a cashless ticketing system. Further, the top box 86 may house different or additional devices than shown in FIG. 14. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g., a master gaming controller) housed within the main cabinet 84 of the machine 3.

Gaming machine 3 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

It may appear that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As is well known in the field, PCs are generally not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware, software, and firmware components and architectures are utilized in gaming machines that are not typically found in general purpose computing devices, such as PCs. These components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normal gaming machine operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

In a preferred embodiment, gaming machines, or gaming platforms generally, are similar to computer platforms in that it is preferable that a gaming machine use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out-of-tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition is generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

A preferred method of operation for gaming machine game software of present invention is to use a state machine. Different functions of a game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, a gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery-backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the time just prior to the malfunction, including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

The gaming machines of the present invention may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine of the present invention by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in the gaming machine to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/1425,098, filed Aug. 8, 2001 and titled “PROCESS VERIFICATION,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming machines that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 13, when a user wishes to play gaming machine 3, he or she inserts cash through the coin acceptor 828 or bill validator 830. Additionally, the bill validator may accept a printed ticket voucher which may be accepted by the bill validator 830 as an indicia of credit when a cashless ticketing system is used. At the start of the game, the player may enter player tracking information using the card reader 824, the keypad 822, and the florescent display 816. Further, other game preferences of the player playing the game may be read from a card inserted into the card reader. During the game, the player views game information using the video display 834. Other game and prize information may also be displayed in the video display screen 845 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 832, the video display screen 834 or using some other device which enables a player to input information into the gaming machine. In some embodiments, the player may be able to access various game services such as concierge services and entertainment content services using the video display screen 834 and one more input devices.

During certain game events, the gaming machine 3 may display visual and auditory effects that can be perceived by the player. These effects add to the excitement of a game, which makes a player more likely to continue playing. Auditory effects include various sounds that are projected by the speakers 810, 812, 814. Visual effects include flashing lights, strobing lights or other patterns displayed from lights on the gaming machine 3 or from lights behind the belly glass 840. After the player has completed a game, the player may receive game tokens from the coin tray 838 or the ticket 820 from the printer 818, which may be used for further games or to redeem a prize. Further, the player may receive a ticket 820 for food, merchandise, or games from the printer 818.

An alternative gaming network that may be used to implement additional methods in accordance with other embodiments of the present invention is depicted in FIG. 14. Gaming establishment 1401 could be any sort of gaming establishment, such as a casino, a card room, an airport, a store, etc. In this example, gaming network 1477 includes more than one gaming establishment, all of which are networked to game server 1422.

Here, gaming machine 1402, and the other gaming machines 1430, 1432, 1434, and 1436, include a main cabinet 1406 and a top box 1404. The main cabinet 1406 houses the main gaming elements and can also house peripheral systems, such as those that utilize dedicated gaming networks. The top box 1404 may also be used to house these peripheral systems.

The master gaming controller 1408 controls the game play on the gaming machine 1402 according to instructions and/or game data from game server 1422 or stored within gaming machine 1402 and receives or sends data to various input/output devices 1411 on the gaming machine 1402. In one embodiment, master gaming controller 1408 includes processor(s) and other apparatus of the gaming machine systems. The master gaming controller 1408 may also communicate with a display 1410.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1408 may also communicate with EFT system 1412, EZPay™ system 1416 (a proprietary cashless ticketing system of the present assignee), and player tracking system 1420. The systems of the gaming machine 1402 communicate the data onto the network 1428 via a communication board 1418.

In another embodiment, mobile gaming devices are in communication with one another or with gaming machines in a peer-to-peer configuration over a suitable data network. Communications links can be established as shown between one mobile gaming device and another. One or more of the mobile gaming devices are configured to operate the same as game server, rather than coupling a separate mobile gaming server to the network. Those skilled in the art will appreciate that the software, hardware or combination thereof within one or more of the mobile gaming devices, described in greater detail below.

Gaming server or servers of the present invention can be effectively removed from the system while maintaining the same functionality. In one example, a plurality of gaming modules are distributed among the various mobile gaming devices and gaming machines. If possible, certain modules are installed on the particular mobile gaming devices where users will likely request those games. When a user requests a particular game on a given device, and that game is not already stored in memory on or accessible by the gaming device it sends a request message to other devices in the network.

It will be appreciated by those of skill in the art that embodiments of the present invention could be implemented on a network with more or fewer elements than are depicted in FIG. 14. For example, player tracking system 1420 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Moreover, player tracking information may be combined with other information that is now readily obtainable by an SBG system.

Moreover, DCU 1424 and translator 1425 are not required for all gaming establishments 1401. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, in the gaming industry, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1442 provides this function for gaming establishment 1401. Site controller 1442 is connected to a central system and/or other gaming establishments via one or more networks, which may be public or private networks. Among other things, site controller 1442 communicates with game server 1422 to obtain game data, such as ball drop data, bingo card data, etc.

In the present illustration, gaming machines 1402, 1430, 1432, 1434 and 1436 are connected to a dedicated gaming network 1428. In general, the DCU 1424 functions as an intermediary between the different gaming machines on the network 1428 and the site controller 1442. In general, the DCU 1424 receives data transmitted from the gaming machines and sends the data to the site controller 1442 over a transmission path 1426. In some instances, when the hardware interface used by the gaming machine is not compatible with site controller 1442, a translator 1425 may be used to convert serial data from the DCU 1424 to a format accepted by site controller 1442. The translator may provide this conversion service to a plurality of DCUs.

Further, in some dedicated gaming networks, the DCU 1424 can receive data transmitted from site controller 1442 for communication to the gaming machines on the gaming network. The received data may be, for example, communicated synchronously to the gaming machines on the gaming network.

Here, CVT 1452 provides cashless and cashout gaming services to the gaming machines in gaming establishment 1401. Broadly speaking, CVT 1452 authorizes and validates cashless gaming machine instruments (also referred to herein as “tickets” or “vouchers”), including but not limited to tickets for causing a gaming machine to display a game result and cash-out tickets. Moreover, CVT 1452 authorizes the exchange of a cashout ticket for cash. These processes will be described in detail below. In one example, when a player attempts to redeem a cash-out ticket for cash at cashout kiosk 1444, cash out kiosk 1444 reads validation data from the cashout ticket and transmits the validation data to CVT 1452 for validation. The tickets may be printed by gaming machines, by cashout kiosk 1444, by a stand-alone printer, by CVT 1452, etc. Some gaming establishments will not have a cashout kiosk 1444. Instead, a cashout ticket could be redeemed for cash by a cashier (e.g. of a convenience store), by a gaming machine or by a specially configured CVT.

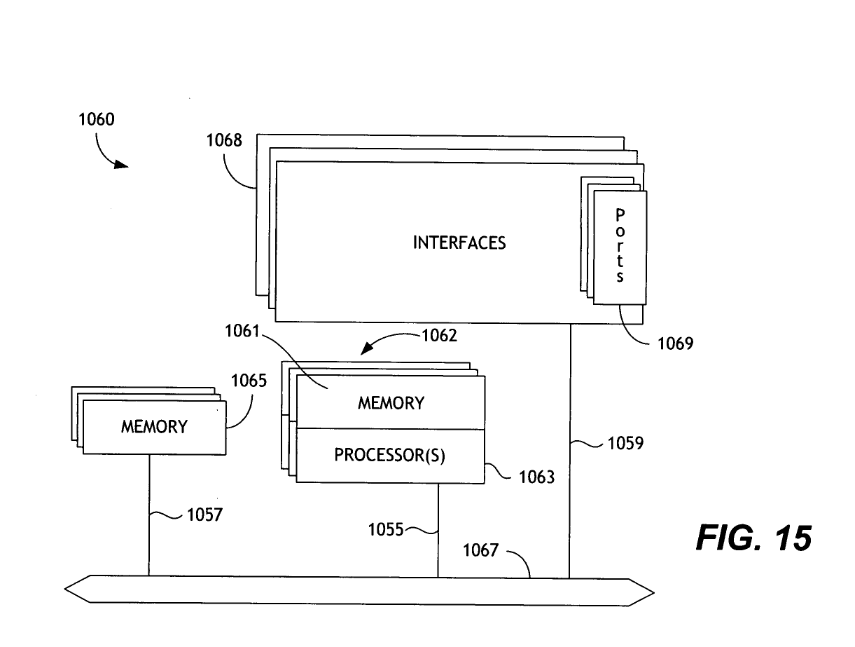

FIG. 15 illustrates an example of a network device that may be configured for implementing some methods of the present invention. Network device 1060 includes a master central processing unit (CPU) 1062, interfaces 1068, and a bus 1067 (e.g., a PCI bus). Generally, interfaces 1068 include ports 1069 appropriate for communication with the appropriate media. In some embodiments, one or more of interfaces 1068 includes at least one independent processor and, in some instances, volatile RAM. The independent processors may be, for example, ASICs or any other appropriate processors. Accordingly, these independent processors perform at least some of the functions of the logic described herein. In other embodiments, one or more of interfaces 1068 control such communications-intensive tasks as encryption, decryption, compression, decompression, packetization, media control and management. By providing separate processors for the communications-intensive tasks, interfaces 1068 allow the master microprocessor 1062 efficiently to perform other functions such as routing computations, network diagnostics, security functions, etc.

The interfaces 1068 are typically provided as interface cards (sometimes referred to as “linecards”). Generally, interfaces 1068 control the sending and receiving of data packets over the network and sometimes support other peripherals used with the network device 1060. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1062 may be responsible for implementing specific functions associated with the functions of a desired network device. According to some embodiments, CPU 1062 accomplishes all these functions under the control of software including an operating system and any appropriate applications software.

CPU 1062 may include one or more processors 1063 such as a processor from the Motorola family of microprocessors or the MIPS family of microprocessors. In an alternative embodiment, processor 1063 is specially designed hardware for controlling the operations of network device 1060. In a specific embodiment, a memory 1061 (such as non-volatile RAM and/or ROM) also forms part of CPU 1062. However, there are many different ways in which memory could be coupled to the system. Memory block 1061 may be used for a variety of purposes such as, for example, caching and/or storing data, programming instructions, etc.

Regardless of the network device's configuration, it may employ one or more memories or memory modules (such as, for example, memory block 1065) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 15 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 15) or switch fabric based (such as a cross-bar).

The above-described devices and materials will be familiar to those of skill in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A wager gaming machine comprising:
a first component;
a first processing unit that controls operation of the first component; and
a power controller that executes in conjunction with the first processing unit, the power controller capable of controlling power supply to the component according to usage pattern data, wherein usage pattern data are derived, at least in part, from activity data for the first component.

2. The wager gaming machine of claim 1 wherein the power controller controls power supply to the first component according to a user-initiated act performed on the gaming machine.

3. The wager gaming machine of claim 2 wherein the power controller controls power supply to the first component according to a combination of the usage pattern data and the user-initiated act.

4. The wager gaming machine of claim 1 further comprising:
a power distribution panel connected to the power controller and capable of receiving a power-related command from the power controller, wherein the power distribution panel supplies power to the first component.

5. The wager gaming machine of claim 1 wherein the power controller further comprises a storage area for storing raw activity data relating to the first component.

6. The wager gaming machine of claim 1 wherein the power controller further comprises a storage area for storing usage pattern data relating to the first component.

7. The wager gaming machine of claim 1 wherein the power controller further comprises:
a pattern-identifying logic module for identifying the usage pattern data from the gaming machine activity data for the first component.

8. The wager gaming machine of claim 1 further comprising:
a second component; and
a second processing unit that controls the second component, wherein the power controller is in communication with the second processing unit and is capable of controlling power supply to the second component.

9. The wager gaming machine of claim 8 further comprising:
a second power controller that executes in conjunction with the second processing unit and is capable of controlling power supply to the second component.

10. The wager gaming machine of claim 1 wherein activity data includes one of: a bill acceptance, a coin acceptance, a printer activation, a card read, a player tracking unit activation, and an input via a user interface component.

11. The wager gaming machine of claim 1 wherein a user-initiated act includes one of: a bill insert, a coin insert, a card insert, a player tracking device insert, and a button press.

12. The wager gaming machine of claim 1 wherein the power controller is a hardware component in the gaming machine.

13. The wager gaming machine of claim 1 wherein the power controller is a software module in the gaming machine.

14. A power control server computer for use in a gaming network having a plurality of wager gaming machine zones, the server computer comprising:
a plurality of zone data repositories, wherein a repository stores activity data for a gaming machine zone and usage pattern data for a gaming machine zone; and
a rules storage area for storing rule and condition data for supplying power to a wager gaming machine in a gaming machine zone, wherein the rule and condition data are derived, at least in part, from usage pattern data for the gaming machine zone.

15. The power control server computer of claim 14 wherein the repository stores activity usage data for a gaming machine component.

16. The power control server computer of claim 14 wherein the repository stores usage pattern data for a gaming machine component

17. The power control server computer of claim 14 further comprising a power controller for processing the rule and condition data to control power to the wager gaming machine.

18. The power control server computer of claim 17 wherein the power controller processes the rule and condition data with a gaming machine signal representing a user-initiated action on a gaming machine to control power to a wager gaming machine.

19. The power control server computer of claim 14 wherein the rule and condition data are derived from usage pattern data for a gaming machine component.

20. A method of controlling power supplied to a wager gaming machine, comprising:
monitoring usage activity of the wager gaming machine;
deriving usage pattern data of the gaming machine based on the usage activity; and
utilizing the usage pattern data to supply power to one or more components of the gaming machine, wherein a component that is not likely to be used at a specific time according to the usage pattern data is provided with power at a level that is below a normal power level of the wager gaming machine.

21. The method of claim 20 further comprising the step of:
generating a local-factor signal representing that a user action has been performed on the wager gaming machine.

22. The method of claim 22 further comprising:
upon generating the local-factor signal, supplying power to a component of the gaming machine that, based on the usage pattern data of the gaming machine, was not being supplied power.

23. The method of claim 20 wherein the step of monitoring usage activity further comprises monitoring usage data for a component of the gaming machine.

24. The method of claim 20 wherein the step of deriving usage pattern data further comprises deriving usage pattern data of a component of the gaming machine based on component usage activity.

25. A method of supplying power to a plurality of components of a first wager gaming machine, the method comprising:
receiving a first signal from a first source, the first signal conveying an initial power-related command relating to at least one component among the plurality of components;
generating a second signal at the wager gaming machine, the second signal conveying a gaming machine-related event, wherein the event indicates use or potential use of the first wager gaming machine;
creating a third signal from the first signal and the second signal, the third signal conveying power-related conditional data; and
generating a final power-related command according to the third signal, the final power-related command relating to the at least one component among the plurality of components.

26. The method of claim 25 further comprising:
utilizing the final power-related command to control power to the plurality of components.

27. The method of claim 25 wherein the first source is a gaming network server.

28. The method of claim 27 wherein the gaming network server is a power control system server.

29. The method of claim 27 wherein the gaming network server is a server-based gaming server.

30. The method of claim 25 wherein a gaming-machine related event includes one of: a bill insert, a coin insert, a card insert, a player tracking device insert, and a button press.

31. The method of claim 25 wherein the third signal embodies the first signal if the second signal is absent and embodies the second signal if the first signal is absent.

32. The method of claim 25 further comprising:
transmitting the final power-related command to a power distribution panel in the first wager gaming machine.

33. The method of claim 25 wherein the first source is a second wager gaming machine.

34. A gaming network comprising:
one or more wager gaming machines having a plurality of components a gaming server, storing
activity data for a gaming machine zone, usage pattern data for a gaming machine zone, and usage pattern data for a wager gaming machine component; and
rule and condition data used in determining power supply to a wager gaming machine; and
a power controller capable of controlling power supply to a wager gaming machine according to the usage pattern data for a gaming machine zone and usage pattern data for a wager gaming machine component.

35. A multi-station wager gaming device comprising:
a central power controller capable of receiving a first signal;
a plurality of wager stations each having one or more components; and
a plurality of power distribution panels, a panel in communication with the central power controller, wherein the central power controller controls power supplied to the one or more components of each wager station of the plurality of wager stations.

36. A wager gaming machine comprising:
a first CPU servicing a first segment of the gaming machine, the first segment having a first set of components and a first power controller that regulates power supply to the first set of components;
a second CPU servicing a second segment of the gaming machine, the second segment having a second set of components and a second power controller that regulates power supply to the second set of components; and
a third CPU servicing a third segment of the gaming machine, the third segment having a third set of components and a third power controller that regulates power supply to the third set of components;
wherein the first, second, and third power controllers execute a power control function capable of accepting a power condition-related signal resulting from one or more of: a usage data input conveying a usage pattern-based power condition, an event-based data input conveying an action taken on the wager gaming machine, and a combination data input created from the usage data input and the event-based data input, whereby an individual gaming machine component consumes power at a level below a normal power level of the component when the component is not expected to be in use.
